(19) United States
(12) Patent Application Publication
(10) Pub. No.: US 2013/0081610 A1
(43) Pub. Date: Apr. 4, 2013

(54) Oven Lighting

(71) Applicants: Christopher L. Eichelberger, Livonia, MI (US); Gary Schneider, Milford, MI (US)

(72) Inventors: Christopher L. Eichelberger, Livonia, MI (US); Gary Schneider, Milford, MI (US)

(73) Assignee: OSRAM Opto Semiconductors GmbH, Regensburg (DE)

(21) Appl. No.: 13/248,353

(22) Filed: Sep. 29, 2011

(51) Int. Cl. F24C 15/00; G02B 6/10; G05D 25/00; F21V 8/00

(52) U.S. Cl. 126/273 R; 362/554; 362/556; 362/552

(57) ABSTRACT

An oven lighting which comprises an LED module with at least one LED and an optical fiber bundle. The optical fiber bundle has at least one light input end adjacent to the LED module and at least one light output end adjacent to a cavity wall of an oven cavity for illuminating the oven cavity.

### FIELD OF THE INVENTION

The invention concerns an oven lighting and an oven comprising the oven lighting.

### BACKGROUND OF THE INVENTION

An oven, in particular a baking oven for household applications, is typically provided with an oven lighting for illuminating the interior of the baking chamber. Usually, incandescent lamps with a glass bulb are used as light sources for oven lightings. A particular problem for oven lightings is that the heat produced by the oven can deteriorate the function of the lamp. This makes is particularly difficult to use modern lighting systems such as LED modules for oven lightings. In particular, the long-term stability of LEDs can be severely reduced by the heat and the temperature changes caused by the oven.

An oven lighting is disclosed in the document EP 2 233 839 A1. This document suggests using a glass lens comprising a cavity for reducing heat conduction towards the light source.

The arrangement of the light source behind a thick glass or other heat resistant window makes it difficult to replace the light source in case it is damaged.

### SUMMARY OF THE INVENTION

It is an object of at least some of the embodiments of the present invention to provide an oven lighting that is distinguished by a reduced difficulty of replacing a damaged light source, an improved long-term stability of the light source, an improved illumination of the oven and the ability to tune the color scheme of the illumination.

In accordance with one embodiment, the oven lighting comprises an LED module with at least one LED. Furthermore, the oven lighting comprises an optical fiber bundle which has at least one light input end adjacent to the LED module, and at least one light output end adjacent to a cavity wall of an oven cavity for illuminating the oven cavity.

In this way, the light emitted by the LED module is advantageously routed by the optical fiber bundle to at least one point at the wall of the oven cavity in order to illuminate the interior of the oven cavity. The optical fiber bundle can comprise a multiplicity of thin optical fibers and is advantageously very flexible. This makes it possible to route the optical fiber bundle along the oven cavity walls to one or more points of the oven walls where the light can enter the oven cavity. The LED module which acts as a light source of the oven lighting can advantageously be arranged in a cooler part of the oven. The LED module is advantageously arranged not directly adjacent to the cavity wall and thus less affected by the heat of the oven. In particular, the LED module is advantageously not subjected to the strongly changing temperatures which can occur close to the oven wall. In this way, the long-term stability of the LED module is improved. Furthermore, the LED module can advantageously be arranged in a part of the oven where it can easily be replaced in the case of a defect.

In a preferred embodiment, the optical fiber bundle is a glass optical fiber bundle. Glass has a good temperature stability and is therefore ideally suited for the use in the hot environment in the vicinity of the oven wall.

In a preferred embodiment, the optical fiber bundle has a plurality of light output ends at the wall of the oven cavity. In particular, the optical fiber bundle can be split into a plurality of branches wherein each branch ends at a light output end at a wall of the oven cavity. In this way, it is achieved that the light emitted by the LED module is directed to various points where it enters the oven cavity. The illumination of the oven cavity is improved in this way in comparison with a single lamp which illuminates the oven cavity only from one spot. In particular, by using an optical fiber bundle having a plurality of light output ends, it is accomplished that the oven cavity is illuminated from a plurality of light entrance points although only one light source is used.

In one preferred configuration, the wall of the oven cavity has a transparent window at the at least one light output end of the optical fiber bundle. In case that the optical fiber bundle has a plurality of light output ends, the cavity wall advantageously has a plurality of transparent windows at each light output end of the optical fiber bundle.

In a preferred embodiment, the transparent window has a light diffusion structure on at least one of its surfaces. For example, the light diffusion structure can be a micro-lens array or a micro-prism array. The light diffusion structure has the advantageous effect that the light exiting the light output end of the optical fiber bundle is diverged, that means that the emission angle is increased. In this way, the uniformity of the illumination of the oven cavity is improved.

In one preferred embodiment, the LED module comprises a plurality of LEDs. For example, the LED module can comprise a plurality of LEDs of the same type in order to increase the light output.

In a particularly preferred embodiment, the plurality of LEDs have different colors and/or different color temperatures. In particular, the LED module can comprise a plurality of white LEDs having different color temperatures. For example, the white LEDs can comprise a high brightness LED which has a high color temperature and thus emits a “cool” white light, and a white light LED which has a lower color temperature and thus emits a “warm” white light. By mixing the light of the different types of white light LEDs in the optical fiber bundle, both high intensity and a desired color temperature can be achieved. Furthermore, it is also possible that the LED module comprises one or more LEDs of different colors, for example red, green and/or blue LEDs. For example, the LED module can comprise at least one RGB LED which comprises three LED chips emitting red, green, and blue light. The RGB LED chips can be arranged in a single LED housing. The RGB LED can be used to generate white light by additive mixture of color. Alternatively, the light emitted by at least one red, green or blue LED can be added to the light of one or more white light LEDs for tuning the color temperature and/or the color rendering index (CRI) of the LED module.

In one preferred embodiment, the optical fiber bundle has a plurality of light input ends. Each light input end is preferably connected to one or more LEDs of the LED module. In this way, it is possible to couple in the light emitted by a plurality of LEDs into the optical fiber bundle very efficiently.

In one preferred embodiment, the optical fibers are randomized in the optical fiber bundle. This means that the optical fibers of the optical fiber bundle are random in position with respect to one another at the one or more light output ends of the fiber bundle. For example, a group of adjacent optical fibers at the light input end is intermixed in the fiber bundle in such a way that they end at random positions of the one or more light output ends. In this way, it can particularly be achieved that the light that is coupled in into a plurality of light input ends of the optical fiber bundle is intermixed in the optical fiber bundle. In case the optical fiber bundle has a plurality of light output ends, the randomized fiber bundle has the effect that the light output at each of the light output ends has approximately the same color.

In one preferred embodiment, the oven lighting comprises a control unit, wherein the control unit is adapted to control the intensity and/or the color of the light emitted by the LED module. Preferably, the control unit is a programmable control unit. In particular, the control unit can be a micro-controller.

In one preferred embodiment, the control unit is adapted to operate the LED module with a plurality of different lighting schemes. The different lighting schemes can, for example, be distinguished by different colors and/or different color temperatures.

In a particularly preferred embodiment, the different lighting schemes comprise different lighting schemes for different types of ovens. In this case, the oven lighting can be supplied for different types of ovens without changing its components, particularly the LED module and the optical fiber bundle. For example, modern ovens are often available in differently colored interiors. In this case, the control unit can be programmed for example in such a way that the LED module provides a color scheme that is adapted to the color of the interior of the oven cavity.

In one embodiment, the present invention is directed to an oven comprising the oven lighting described above.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail below on the basis of exemplary embodiments in association with FIGS. 1 to 4.

FIG. 1 shows a schematically illustrated cross-section through an oven having an oven lighting according to an exemplary embodiment,

FIG. 2 shows a schematically illustrated cross-section through a region adjacent to the light input end according to an embodiment,

FIG. 3 shows a schematically illustrated cross-section through a region adjacent to the light input end according to a further embodiment, and

FIG. 4 shows a schematically illustrated cross-section through a region adjacent to the light output end according to a further embodiment.

### DETAILED DESCRIPTION OF THE DRAWINGS

Identical or identically acting constituent parts are provided with the same reference symbols in the figures. The illustrated constituent parts and also the size relationships of the constituent parts with respect to one another should not be regarded as true to scale.

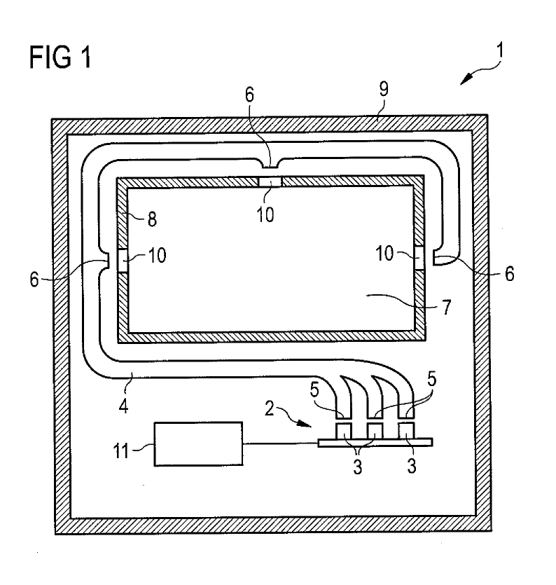

The oven 1 illustrated in FIG. 1 has a cavity 7 which can be a baking chamber, for example. The oven 1 comprises an oven lighting which uses an LED module 2 as a light source. The LED module 2 preferably has a plurality of LEDs 3. The LEDs 3 can be arranged on a common carrier. For example, the LEDs 3 can be arranged in a row or in an array.

The light emitted by the LEDs 3 is coupled in into a plurality of light input ends 5 of an optical fiber bundle 4. The optical fiber bundle 4 acts as a light guide which guides the light to a plurality of light output ends 6 of the optical fiber bundle 4. The light output ends 6 are arranged adjacent to a cavity wall 8 of the oven cavity 7.

In the region of the light output ends 6 of the optical fiber bundle 4, the cavity wall 8 has transparent windows 10 so that the light escaping from the light output ends 6 of the optical fiber bundle 4 can illuminate the interior of the oven cavity 7. Due to the fact that the optical fiber bundle 4 has a plurality of light output ends 6, the oven cavity 7 can advantageously be illuminated from a plurality of positions, although the oven lighting has only one LED module 2 as a light source.

The optical fiber bundle 4 comprises a multiplicity of optical fibers. The optical fiber bundle 4 is advantageously very flexible and can thus be guided through a space between the cavity wall 8 and an outer oven wall 9.

The optical fiber bundle 4 is preferably a glass optical fiber bundle 4. In this case, the optical fiber bundle 4 comprises a multiplicity of glass optical fibers. The glass optical fiber bundle 4 has the advantage of a high temperature stability and can therefore be guided along the wall 8 of the oven cavity 7, that means through a region where high temperatures can occur.

Since the light emitted by the LED module 2 is guided to the cavity 7 by the optical fiber bundle 4, the LED module 2 can advantageously be arranged in a cooler region of the oven 1. In particular, it is not necessary to arrange the LED module 2 in the vicinity of the cavity wall 8. This has the advantage that the LEDs 3 are not significantly affected by the heat generated by the oven 1. This allows the use of LEDs 3 that would not withstand the heat generated by the oven 1. Furthermore, the long-term stability of the LED module 2 is improved because the LED module 2 is advantageously not significantly affected by the temperature changes during heating and cooling down the oven 1.

The LED module 2 can advantageously be arranged in a position of the oven 1 where it can easily be replaced in case of a breakdown. In particular, it is not necessary to arrange the LED module 2 in a region behind the cavity wall 8 where it would be difficult to access.

The LEDs 3 of the LED module 2 can have different colors and/or different color temperatures. In particular, the LED module 2 can comprise two or more white light emitting LEDs 3 which have different color temperatures, for example one LED 3 with a cool color shade and one LED 3 with a warm color shade. In addition, the LED module 2 may comprise one or more colored LEDs 3 which emit, for example, red, green or blue radiation. In particular, the LED module 2 can comprise an LED 3 which comprises multiple LED chips of different colors.

The optical fiber bundle 4 is advantageously divided into a plurality of branches in the region adjacent to the LED module 2 so that it has a plurality of light input ends 5. Each of the light input ends 5 is attributed to one of the LEDs 3 or to a group of the LEDs 3.

Preferably, the optical fibers are randomized in the optical fiber bundle 4. In other words, each of the light output ends 6 of the optical fiber bundle 4 comprises a number of optical fibers which is a random selection of optical fibers from the different light input ends 5. In this way, the light entering the multiple light input ends 5 of the optical fiber bundle 4 is intermixed on its way to the light output ends 6. In particular, the light of LEDs 3 with different colors can be intermixed in the optical fiber bundle 4. In this way, it is achieved that the light output ends 6 emit light of approximately the same color.

The LED module 2 is advantageously controlled by a control unit 11. Preferably, the control unit 11 is a programmable control unit, for example a micro-controller. The control unit is adapted to control the intensity and/or the color of the light emitted by LED module 2. In particular, the control unit 11 controls the power supplied to the different LEDs 3.

Preferably, the control unit 11 is adapted to operate the LED module 2 with a plurality of different lighting schemes. The lighting schemes can be distinguished by different colors, color temperatures and/or color rendering indices. The control unit 11 can comprise a data storage for a plurality of different lighting schemes.

In a preferred embodiment, the plurality of lighting schemes comprise lighting schemes for different types of ovens 1. For example, the different lighting schemes can be adapted to different colors of the interior of the oven cavity 7.

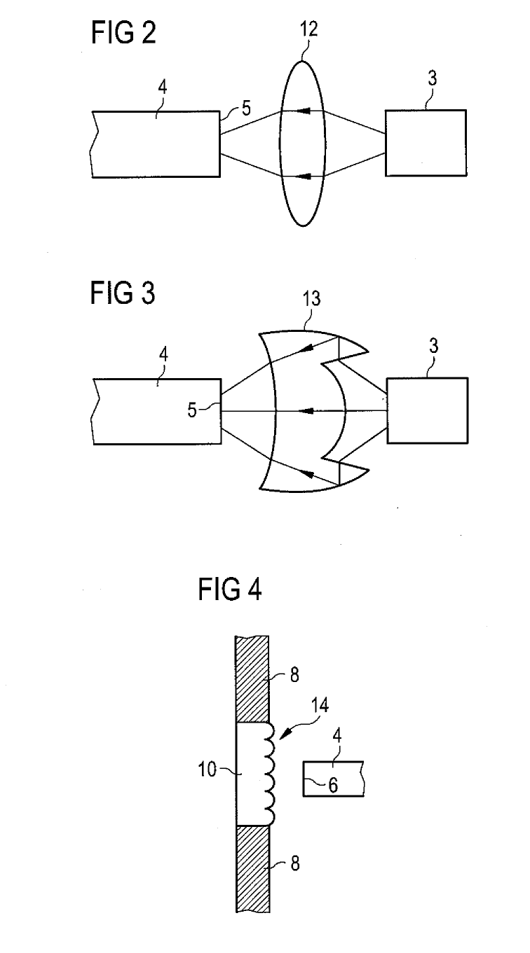

In order to couple in the light emitted by an LED 3 into a light input end 5 of the optical fiber bundle 4, an optical element can be arranged between the LED 3 and the light input end 5. As shown in FIG. 2, a lens 12 may be arranged between the LED 3 and its assigned light input end 5 of the optical fiber bundle 4. The lens 12 advantageously focuses the radiation of the LED 3 into the light input end 5 of the optical fiber bundle 4 and improves coupling in the radiation into the optical fiber bundle 4 in this way.

In the preferred embodiment which is shown in FIG. 3, the optical element between the LED 3 and the light input end 5 of the optical fiber bundle 4 is a TIR (Total Internal Reflection) lens 13. By making use of total internal reflection, the TIR lens 13 collects and focuses light of a large entrance angle region and is therefore very effective to collect the light which emitted by an LED 3 into a large emission angle region.

FIG. 4 shows a detailed view of the transparent optical window 10 in the cavity wall 8 according to an embodiment. In this case, the transparent optical window 10 advantageously comprises a light diffusion structure 14. For example, the light diffusion structure 14 is a micro-lens array. Alternatively, the light diffusion structure 14 may also be a micro-prism array or any other micro-structure that is suited to diffuse light. Preferably, the light diffusion structure is arranged on the outer surface of the transparent optical window 10, that means on the surface which is remote from the oven chamber 7. The light diffusion structure 14 advantageously diffuses the light emitted from the light output end 6 of the optical fiber bundle 4 and improves in this way the uniformity of the illumination of the oven chamber 7.

The scope of protection of the invention is not limited to the examples given hereinabove. The invention is embodied in each novel characteristic and each combination of characteristics, which particularly includes every combination of any features which are stated in the claims, even if this feature or this combination of features is not explicitly stated in the claims or in the examples.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An oven lighting, comprising:
an LED module with at least one LED; and
an optical fiber bundle,
wherein the optical fiber bundle has at least one light input end adjacent to the LED module, and at least one light output end adjacent to a cavity wall of an oven cavity for illuminating the oven cavity.

2. The oven lighting according to claim 1, wherein the optical fiber bundle is a glass optical fiber bundle.

3. The oven lighting according to claim 1, wherein the optical fiber bundle has a plurality of light output ends at the cavity wall.

4. The oven lighting according to claim 1, wherein the cavity wall has a transparent window at the at least one light output end of the optical fiber bundle.

5. The oven lighting according to claim 4, wherein the transparent window has a light diffusion structure.

6. The oven lighting according to claim 1, wherein the LED module comprises a plurality of LEDs.

7. The oven lighting according to claim 6, wherein the plurality of LEDs have different colors and/or different color temperatures.

8. The oven lighting according to claim 6, wherein the optical fiber bundle has a plurality of light input ends.

9. The oven lighting according to claim 1, wherein the optical fiber bundle comprises a plurality of optical fibers which are randomized in the optical fiber bundle.

10. The oven lighting according to claim 1, further comprising a control unit which is adapted to control the intensity and/or the color of the light emitted by the LED module.

11. The oven lighting according to claim 10, wherein the control unit is adapted to operate the LED module with a plurality of different lighting schemes.

12. The oven lighting according to claim 11, wherein the plurality of lighting schemes comprise lighting schemes for different types of ovens.

13. An oven, comprising an oven lighting according to claim 1.
